(19) United States
(12) Patent Application Publication
(10) Pub. No.: US 2024/0430700 A1
(43) Pub. Date: Dec. 26, 2024

(54) UPDATING OF JOINT TRANSMISSION CONFIGURATION INDICATION STATES FOR COMMUNICATION DEVICES

(71) Applicant: Huawei Technologies Co., Ltd., Shenzhen (CN)

(72) Inventors: Salah Eddine Hajri, Lund (SE); Gustaf Claeson, Lund (SE)

(21) Appl. No.: 18/828,078

(22) Filed: Sep. 9, 2024

Related U.S. Application Data
(63) Continuation of application No. PCT/EP2022/056169, filed on Mar. 10, 2022.

(51) Int. Cl. H04W 16/28; H04W 8/22; H04W 76/20

(52) U.S. Cl. CPC H04W 16/28; H04W 8/22; H04W 76/20

(57) ABSTRACT

The disclosure provides methods, devices, and non-transitory computer-readable storage media. An example method includes determining a transmission configuration indication (TCI) state update for an active joint TCI state upon detecting or predicting a rotation of the first communication device around at least one rotational axis of the first communication device. The active joint TCI state associates at least one reception spatial filter of the first communication device with at least one transmission spatial filter of a second communication device, or at least one transmission spatial filter of the first communication device with at least one reception spatial filter of the second communication device. The example method further includes transmitting a TCI update message to the second communication device. The TCI update message indicates the TCI state update.

### CROSS-REFERENCE TO RELATED APPLICATIONS

This application is a continuation of International Application No. PCT/EP2022/056169, filed on Mar. 10, 2022, the disclosure of which is hereby incorporated by reference in its entirety.

### TECHNICAL FIELD

The disclosure relates to transmission configuration indication state updates for active joint transmission configuration indication states between a first communication device and a second communication device in a communication system. Furthermore, the disclosure relates to corresponding methods and a computer program.

### BACKGROUND

In 3GPP, two antenna ports are said to be quasi co-located (QCLed) if properties of the radio channel over which a symbol on one antenna port is conveyed can be inferred from the channel over which a symbol on the other antenna port is conveyed. The concerned properties of the channel include Doppler shift, Doppler spread, average delay, delay spread and/or spatial parameters.

Transmission configuration indication (TCI) can be sent in downlink control information (DCI) to indicate a QCL relationship between a target reference signal (RS) in uplink (UL) and/or downlink (DL) channels and a source RS. A user equipment (UE) may e.g., assume that a spatial filter used to transmit a given physical downlink shared channel (PDSCH) is the same as the filter used to transmit the source RS in the QCL relation indicated by the TCI state. One of the main use cases for dynamic TCI is to dynamically indicate transmission and/or reception beams.

During 3GPP Rel-17 discussion, a unified TCI framework supporting joint UL and DL TCI was a feature of interest. The main motivation behind considering a unified TCI framework was the fact that independent UL and DL beam indication requires a relatively high signaling overhead. Additionally, as the indication of TCI states for different channels and RSs in UL and DL, respectively, are performed using different methods, misalignment in the time domain of application of reception or transmission beams can become problematic.

### SUMMARY

An objective of embodiments of the invention is to provide a solution which mitigates or solves the drawbacks and problems of conventional solutions.

Another objective of embodiments of the invention is to provide a solution which addresses issues specific to indication of joint TCI states and to provide a flexible solution for updating active joint TCI states.

The above and further objectives are solved by the subject matter of the independent claims. Further embodiments of the invention can be found in the dependent claims.

According to a first aspect of the invention, the above mentioned and other objectives are achieved with a first communication device for a communication system, the first communication device being configured to:

determine a transmission configuration indication, TCI, state update for an active joint TCI state upon detecting or predicting a rotation of the first communication device around at least one rotational axis of the first communication device, the active joint TCI state associating at least one reception spatial filter of the first communication device with at least one transmission spatial filter of a second communication device or at least one transmission spatial filter of the first communication device with at least one reception spatial filter of the second communication device; and

transmit a TCI update message to the second communication device, the TCI update message indicating the TCI state update.

The active joint TCI state may be a joint TCI state configured for the first communication device and activated to be potentially used for an ongoing transmission by the second communication device. An activated joint TCI state that is to be used for an ongoing transmission is thereafter indicated by the second communication device.

It may be understood that a transmission beam may be defined or given by its associated transmission spatial filter and, correspondingly, a reception beam may be defined or given by its associated reception spatial filter. The association of spatial filters may relate to transmissions from the second communication device to the first communication device or in the opposition direction from the first communication to the second communication. In the first type of transmission, the association is between transmission spatial filter(s) of the second communication device with reception spatial filter(s) of the first communication device. In the second type of transmission, the association is between transmission spatial filter(s) of the first communication device with reception spatial filter(s) of the second communication device. The first type of transmission is, in some communication systems, denoted downlink transmission (DL) and the second type of transmission is denoted uplink transmission (UL) over the Uu interface.

An advantage of the first communication device according to the first aspect is that the first communication device and the second communication device are able to perform any needed QCL assumption and joint TCI state correction rapidly, consequently reducing beam failure or link drop probability. Additionally, any eventual beam correction could be determined, at least coarsely, using a minimal number of RS transmissions. In some scenarios, latency and reliability are among the main key performance indicator (KPIs), e.g., in Ultra reliable and low latency communication (URLLC) and in eXtended Reality (XR) traffic. In these situations, the delay constraints to correct any beam misalignment between the UL and DL are quite stringent and a centric solution from the perspective of the first communication device can enable fast reactive measures and proactive beam handling.

In an implementation form of a first communication device according to the first aspect, the TCI state update indicates a shift in the association of the active joint TCI state of at least one reception spatial filter of the first communication device with at least one transmission spatial filter of the second communication device or at least one transmission spatial filter of the first communication device with at least one reception spatial filter of the second communication device.

An advantage with this implementation form is that the TCI state update indicates an extent of change in orientation of the first communication device. Thereby, enabling the second communication device to choose the appropriate reaction such as beam correction.

In an implementation form of a first communication device according to the first aspect, the TCI state update is associated with a single antenna of the first communication device or a plurality of antennas of the first communication device.

An antenna herein may also be denoted as an antenna panel or, in short, a panel.

An advantage with this implementation form is that the first communication device can transmit a common joint TCI state update message for all its active antenna panels or a joint TCI state update message per antenna panel. Depending on the capabilities of the first communication device, it may use multiple antenna panels to communicate with one or multiple second communication devices. In this case, it is usually necessary to perform a joint TCI state in an antenna panel specific manner as, depending on the layout of the antenna panels, the extent of the needed correction may be different from one antenna panel to another antenna panel.

In an implementation form of a first communication device according to the first aspect, the TCI state update indicates the rotation of the first communication device.

An advantage with this implementation form is that the first communication device can inform the second communication device about its rotation impacting the validity of currently active joint TCI states, thereby enabling the second communication device to distinguish between a blockage situation and a rotation situation. Unnecessary RS measurements can hence be avoided and the latency for adapting joint TCI states can be reduced.

In an implementation form of a first communication device according to the first aspect, the first communication device is further configured to determine the TCI state update based on a reference joint TCI state.

An advantage with this implementation form is that by deriving the joint TCI state update with respect to a reference joint TCI state, reporting format, such as bit-width to convey the TCI state update indication, may be optimized.

In an implementation form of a first communication device according to the first aspect, the reference joint TCI state is the latest joint TCI state indicated by the second communication device.

The latest joint TCI state may be associated with any of DL or UL reception or transmission between the first communication device and the second communication device.

An advantage with this implementation form is that both the first communication device and the second communication device know the current joint TCI state reference and there will be no ambiguity in the TCI update message, even without dedicated explicit reference TCI state indications.

In an implementation form of a first communication device according to the first aspect, the first communication device is further configured to detect or predict the rotation of the first communication device based on reference signal measurements and/or an output from internal sensors of the first communication device.

An advantage with this implementation form is that the rotation can be detected or predicted based on RS measurements and/or output from internal sensors at the first communication device, thereby reducing the latency associated with adapting the joint TCI states.

In an implementation form of a first communication device according to the first aspect, the first communication device is further configured to transmit a TCI update capability message to the second communication device, the TCI update capability message indicating a TCI update capability of the first communication device.

An advantage with this implementation form is that the second communication device is made aware of whether the first communication device is capable of proactive or reactive joint TCI state update.

In an implementation form of a first communication device according to the first aspect, the first communication device is further configured to:
receive a TCI update configuration message from the second communication device, the TCI update configuration message indicating a reporting format and/or reporting resources for the TCI update message; and
determine the TCI update message based on the TCI update configuration message.

The TCI update configuration message may further indicate time domain reporting behavior of joint TCI state update transmission, i.e., periodic, aperiodic, event-triggered, and semi-persistent joint TCI state update transmission. To determine the TCI update message based on the TCI update configuration message may also imply that the TCI update message is also transmitted based on the TCI update configuration message.

An advantage with this implementation form is that different bit-widths for the joint TCI state update messages may be supported. Additionally, the reporting resources can be selected so that minimum collision with other UL transmission could occur. The diversity of the time domain reporting behavior of joint TCI state update messages enables the network to configure whichever behavior that suites the characteristics of the traffic and mobility of the first communication device.

In an implementation form of a first communication device according to the first aspect, the first communication device is further configured to switch at least one reception/transmission spatial filter of the first communication device and/or at least one transmission/reception spatial filter of the first communication device based on the TCI state update.

An advantage with this implementation form is that the first communication device updates its transmission/reception spatial filters, upon determining an appropriate TCI state update. Consequently, any problematic beam misalignment that could result from the rotation can be corrected rapidly before having a detrimental impact of an ongoing transmission.

In an implementation form of a first communication device according to the first aspect, the first communication device is a first client device, and the second communication device is a second client device or a network access node.

Hence, both communications over the Uu interface and the sidelink interface may be supported.

According to a second aspect of the invention, the above mentioned and other objectives are achieved with a second communication device for a communication system, the second communication device being configured to:

transmit a transmission configuration indication, TCI, control message to a first communication device, the TCI control message indicating an active joint TCI state for the first communication device, the active joint TCI state associating at least one reception spatial filter of the first communication device with at least one transmission spatial filter of a second communication device or at least one transmission spatial filter of the first communication device with at least one reception spatial filter of the second communication device;
receive a TCI update message from the first communication device, the TCI update message indicating a TCI state update for the active joint TCI state; and
determine an updated active joint TCI state for the first communication device based on the TCI update message.

An advantage of the second communication device according to the second aspect is that the first communication device and the second communication device are able to perform any needed QCL assumption and joint TCI state correction rapidly, consequently reducing beam failure or link drop probability. Additionally, any eventual beam correction could be determined, at least coarsely, using a minimal number of RS transmissions. In some scenarios, latency and reliability are among the main KPIs, e.g., in URLLC and in XR traffic. In these situations, the delay constraints to correct any beam misalignment between the UL and DL are quite stringent and a centric solution from the perspective of the first communication device can enable fast reactive measures and proactive beam handling.

In an implementation form of a second communication device according to the second aspect, the TCI state update indicates a shift in the association of the active joint TCI state of at least one reception spatial filter of the first communication device with at least one transmission spatial filter of a second communication device or at least one transmission spatial filter of the first communication device with at least one reception spatial filter of the second communication device.

An advantage with this implementation form is that the TCI state update indicates an extent of change in orientation of the first communication device, thereby enabling the second communication device to choose the appropriate reaction such as beam correction.

In an implementation form of a second communication device according to the second aspect, the TCI state update is associated with a single antenna of the first communication device or a plurality of antennas of the first communication device.

An advantage with this implementation form is that the first communication device can transmit a common joint TCI state update message for all its active antenna panels or a joint TCI state update message per antenna panel. Depending on the capabilities of the first communication device, it may use multiple antenna panels to communicate with one or multiple second communication devices. In this case, it is usually necessary to perform a joint TCI state in an antenna panel specific manner as, depending on the layout of the antenna panels, the extent of the needed correction may be different from one antenna panel to another antenna panel.

In an implementation form of a second communication device according to the second aspect, the TCI state update indicates a rotation of the first communication device around at least one rotational axis of the first communication device.

An advantage with this implementation form is that the first communication device can inform the second communication device about its rotation impacting the validity of currently active joint TCI states, thereby enabling the second communication device to distinguish between a blockage situation and a rotation situation. Unnecessary RS measurements can hence be avoided and the latency for adapting joint TCI states can be reduced.

In an implementation form of a second communication device according to the second aspect, the second communication device is further configured to determine the updated active joint TCI state further based on one or more in the group comprising channel state information, radio resource management measurements, and positioning measurements.

An advantage with this implementation form is that by considering further relevant information improved beam correction is possible.

In an implementation form of a second communication device according to the second aspect, the second communication device is further configured to transmit a TCI control message to the first communication device, the TCI control message indicating the updated active joint TCI state.

Thereby, a mechanism in which the second communication device controls or overrides the update of the active joint TCI state for an ongoing transmission is provided.

In an implementation form of a second communication device according to the second aspect, the second communication device is further configured to:
receive a TCI update capability message from the first communication device, the TCI update capability message indicating a TCI update capability of the first communication device;
determine a reporting format and/or reporting resources for the TCI update message based on the TCI update capability message; and
transmit a TCI update configuration message to the first communication device, the TCI update configuration message indicating the reporting format and/or the reporting resources for the TCI update message.

An advantage with this implementation form is that the second communication device is made aware of whether the first communication device is capable of proactive or reactive joint TCI state update. Further, different bit-widths for the joint TCI state update messages may be supported. Additionally, the reporting resources can be selected so that minimum collision with other UL transmission could occur. The diversity of the time domain reporting behavior of joint TCI state update messages enables the network to configure whichever behavior that suites the characteristics of the traffic and mobility of the first communication device.

In an implementation form of a second communication device according to the second aspect, the first communication device is a first client device, and the second communication device is a second client device or a network access node.

Hence, both communications over the Uu interface and the sidelink interface may be supported.

According to a third aspect of the invention, the above mentioned and other objectives are achieved with a method for a first communication device, the method comprising:
determining a TCI state update for an active joint TC state upon detecting or predicting a rotation of the first communication device around at least one rotational axis of the first communication device, the active joint TCI state associating at least one reception spatial filter of the first communication device with at least one transmission spatial filter of a second communication device or at least one transmission spatial filter of the first communication device with at least one reception spatial filter of the second communication device; and
transmitting a TCI update message to the second communication device, the TCI update message indicating the TCI state update.

The method according to the third aspect can be extended into implementation forms corresponding to the implementation forms of the first communication device according to the first aspect. Hence, an implementation form of the method comprises the feature(s) of the corresponding implementation form of the first communication device.

The advantages of the methods according to the third aspect are the same as those for the corresponding implementation forms of the first communication device according to the first aspect.

According to a fourth aspect of the invention, the above mentioned and other objectives are achieved with a method for a second communication device, the method comprising:
transmitting a transmission configuration indication, TCI, control message to a first communication device, the TCI control message indicating an active joint TCI state for the first communication device, the active joint TC state associating at least one reception spatial filter of the first communication device with at least one transmission spatial filter of a second communication device or at least one transmission spatial filter of the first communication device with at least one reception spatial filter of the second communication device;
receiving a TCI update message from the first communication device, the TCI update message indicating a TCI state update for the active joint TCI state; and
determining an updated active joint TCI state for the first communication device based on the TCI update message.

The method according to the fourth aspect can be extended into implementation forms corresponding to the implementation forms of the second communication device according to the second aspect. Hence, an implementation form of the method comprises the feature(s) of the corresponding implementation form of the second communication device.

The advantages of the methods according to the fourth aspect are the same as those for the corresponding implementation forms of the second communication device according to the second aspect.

Embodiments of the invention also relates to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a first communication device according to an embodiment of the invention;

FIG. 2 shows a flow chart of a method for a first communication device according to an embodiment of the invention;

FIG. 3 shows a second communication device according to an embodiment of the invention;

FIG. 4 shows a flow chart of a method for a second communication device according to an embodiment of the invention;

FIG. 5 illustrates different transmission and reception beams over the Uu and SL interfaces;

FIGS. 6a-b show a communication system according to an embodiment of the invention;

FIG. 7 shows rotational axes of a first communication device;

FIG. 8 shows signaling for TCI state update according to an embodiment of the invention;

FIGS. 9a-b show a switch of reception spatial filter based on a TCI update according to an embodiment of the invention;

FIG. 10 shows signaling for configuration of TCI state updates according to an embodiment of the invention; and

FIG. 11 shows signaling for TCI state update according to an embodiment of the invention.

### DETAILED DESCRIPTION

In 3GPP Rel-17, joint UL and DL TCI state indication is supported using joint TCI state code point indication in downlink control signaling. While multiple enhancements can be derived from this new feature, there are some vulnerabilities that may arise. Joint TCI state code points establish an association between UL and DL TCI states. This means that, in situations where only an UL TCI state or a DL TCI state needs to be changed, the network would need to correct multiple joint TCI states and more RS measurements than actually needed may be required. A work-around solution would be to increase the number of joint TCI state code points. However, that would result in increased bit width of the relevant field in DCI, resulting in higher DCI payload which may impact control information decoding.

In the currently specified beam management procedure, when the network detects a drop in the link quality, it may perform both DL beam reporting and UL beam refinement through UL RS measurements in order to pinpoint which side of the link is impacted, i.e., UL or DL and to detect the reason for such quality drop, i.e., blockage or device rotation. These two procedures involve non negligible delays and reference signals transmissions and measurements. Thus, knowing the reason for the link quality drop can help the network to take the proper action, with the lowest possible amount of RS transmissions.

When a UE is rotating or will undergo a rotation along any of its spatial axis, a TCI state issue would likely impact UL only, i.e., UL reception and/or transmission beams. As information relevant to orientation of the UE can be easily derived at the UE side, either through its own internal sensors and/or DL RS measurements, it makes sense to leverage such information to avoid unnecessary delays and RS measurements for beam correction/realignment.

In 3GPP 5G new radio (NR), some features leverage UE-initiated indications, e.g., beam failure recovery and event-triggered cross-link interference (CLI) measurement. Relying on the UE in such manner guarantees fast reactivity to beam blockage and CLI bursts, respectively. The advantages of such behavior, i.e., UE-triggered reporting, cannot be understated. Especially in terms of link adaptation and mobility support. This UE-centric behavior can be leveraged to optimize beam management procedure, especially for multi-panel, multi-transmission reception point (TRP) scenarios where additional variables are in play. Indeed, maintaining the alignment of multiple UL and DL beams can prove complicated, especially if the network has no a priori information about the UE antenna panel layouts, which is usually the case.

Therefore, according to embodiments of the invention a mechanism for updating joint TCI states is proposed which leverage information available at the UE about UE device rotation and orientation. The solution can e.g., simplify beam management, especially for multi-panel UEs (MPUEs) in multi-TRP scenarios.

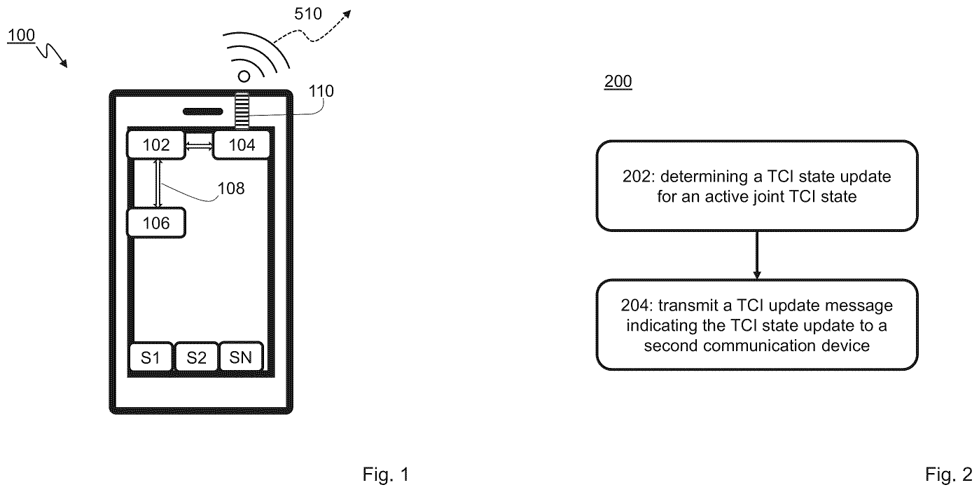

FIG. 1 shows a first communication device 100 according to an embodiment of the invention. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 further comprises an antenna array 11o coupled to the transceiver 104, which means that the first communication device 100 is configured for wireless communications in a communication system. The antenna array 11o comprises a plurality of antenna panels having different orientations. The first communication device 100 may use one or multiple antenna panels for transmission or reception. The spatial filters that the first communication device 100 applies at each of the antenna panels may be different.

The processor 102 may be referred to as one or more general-purpose CPU, one or more digital signal processor (DSP), one or more application-specific integrated circuit (ASIC), one or more field programmable gate array (FPGA), one or more programmable logic device, one or more discrete gate, one or more transistor logic device, one or more discrete hardware component, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices. The transceiver 104, memory 106 and/or processor 102 may be implemented in separate chipsets or may be implemented in a common chipset.

That the first communication device 100 is configured to perform certain actions can in this disclosure be understood to mean that the first communication device 100 comprises suitable means, such as e.g., the processor 102 and the transceiver 104, configured to perform the actions.

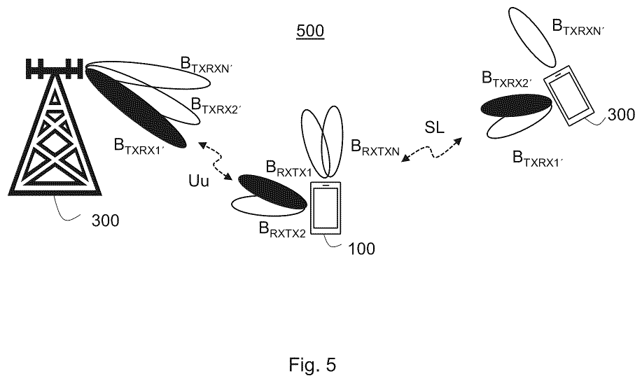

According to embodiments of the invention and with reference to FIG. 1, 5a-5b, and 6, the first communication device 100 is configured to determine a TCI state update for an active joint TCI state upon detecting or predicting a rotation of the first communication device 100 around at least one rotational axis A1, A2, A3 of the first communication device 100. The active joint TCI state associates at least one reception spatial filter B_{RXTX1}, B_{RXTX2}, . . . , B_{RXTXN} of the first communication device 100 with at least one transmission spatial filter B_{TXRX1′}, B_{TXRX2′}, . . . , B_{TXRXN′} of a second communication device 300 or at least one transmission spatial filter B_{RXTX1}, B_{RXTX2}, . . . , B_{RXTXN} of the first communication device 100 with at least one reception spatial filter B_{TXRX1′}, B_{TXRX2′}, . . . , B_{TXRXN′} of the second communication device 300, as further described with reference to FIGS. 5a-b. The first communication device 100 is further configured to transmit a TCI update message 510 to the second communication device 300, the TCI update message 510 indicating the TCI state update.

FIG. 2 shows a flow chart of a corresponding method 200 which may be executed in a first communication device 100, such as the one shown in FIG. 1. The method 200 comprises determining 202 a TCI state update for an active joint TCI state upon detecting or predicting a rotation of the first communication device 100 around at least one rotational axis A1, A2, A3 of the first communication device 100. The active joint TCI state associates at least one reception spatial filter B_{RXTX1}, B_{RXRX2}, . . . , B_{RXTXN} of the first communication device 100 with at least one transmission spatial filter B_{TXRX1′}, B_{TXRX2′}, . . . , B_{TXRXN′} of a second communication device 300 or at least one transmission spatial filter B_{RXTX1}, B_{RXTX2}, . . . , B_{RXTXN} of the first communication device 100 with at least one reception spatial filter B_{TXRX1′}, B_{TXRX2′}, . . . , B_{TXRXN′} of the second communication device 300. The method 200 further comprises transmitting 204 a TCI update message 510 to the second communication device 300, the TCI update message 510 indicating the TCI state update.

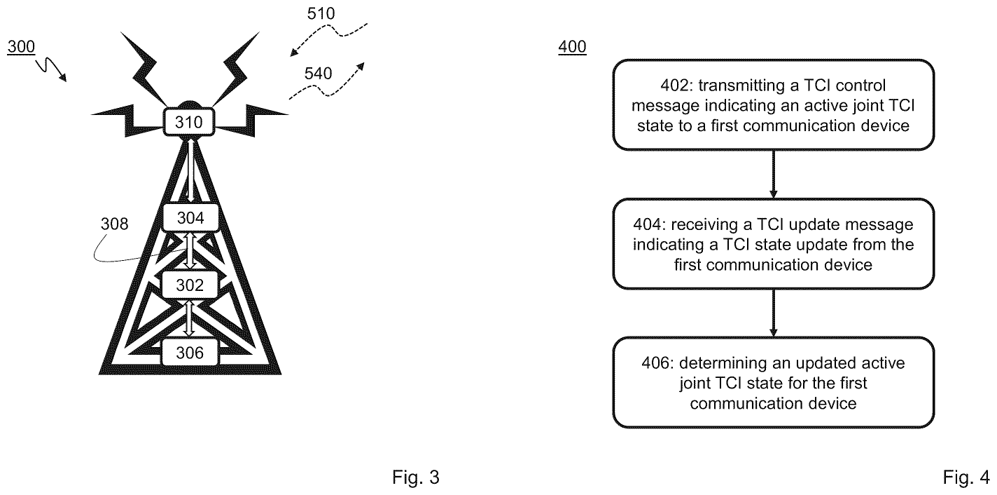

FIG. 3 shows a second communication device 300 according to an embodiment of the invention. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 comprises an antenna or antenna array 310 coupled to the transceiver 304. The antenna array 310 comprises a plurality of antenna panels having different orientations. The second communication device 300 may use one or multiple antenna panels for transmission or reception. The spatial filters that the second communication device 300 applies at each of the antenna panels may be different.

The processor 302 may be referred to as one or more general-purpose CPU, one or more digital signal processor (DSP), one or more application-specific integrated circuit (ASIC), one or more field programmable gate array (FPGA), one or more programmable logic device, one or more discrete gate, one or more transistor logic device, one or more discrete hardware component, one or more chipset. The memory 306 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 304, the memory 306 and/or the processor 302 may be implemented in separate chipsets or may be implemented in a common chipset.

That the second communication device 300 is configured to perform certain actions can in this disclosure be understood to mean that the second communication device 300 comprises suitable means, such as e.g., the processor 302 and the transceiver 304, configured to perform the actions.

According to embodiments of the invention and with reference to FIG. 3, 5a-b, and 6, the second communication device 300 is configured to transmit a TCI control message 540 to a first communication device 100. The TCI control message 540 indicates an active joint TCI state for the first communication device 100 and the active joint TCI state associates at least one reception spatial filter B_{RXTX1}, B_{RXTX2}, . . . , B_{RXTXN} of the first communication device 100 with at least one transmission spatial filter B_{TXRX1′}, B_{TXRX2′}, . . . , B_{TXRXN′} of the second communication device 300 or at least one transmission spatial filter B_{RXTX1}, B_{RXTX2}, . . . , B_{RXTXN} of the first communication device 100 with at least one reception spatial filter B_{TXRX1′}, B_{TXRX2′}, . . . , B_{TXRXN′} of the second communication device 300. The second communication device 300 is further configured to receive a TCI update message 510 from the first communication device 100, the TCI update message 510 indicating a TCI state update for the active joint TCI state. The second communication device 300 is further configured to determine an updated active joint TCI state for the first communication device 100 based on the TCI update message 510.

FIG. 4 shows a flow chart of a corresponding method 400 which may be executed in a second communication device 300, such as the one shown in FIG. 3. The method 400 comprises transmitting 402 a TCI control message 540 to a first communication device 100. The TCI control message 540 indicates an active joint TCI state for the first communication device 100 and the active joint TCI state associates at least one reception spatial filter B_{RXTX1}, B_{RXTX2}, . . . , B_{RXTXN} of the first communication device 100 with at least one transmission spatial filter B_{TXRX1′}, B_{TXRX2′}, . . . , B_{TXRXN′} of the second communication device 300 or at least one transmission spatial filter B_{RXTX1}, B_{RXTX2}, . . . , B_{RXTXN} of the first communication device 100 with at least one reception spatial filter B_{TXRX1′}, B_{TXRX2′}, . . . , B_{TXRXN′} of the second communication device 300. The method 400 further comprises receiving 404 a TCI update message 510 from the first communication device 100, the TCI update message 510 indicating a TCI state update for the active joint TCI state. The method 400 further comprises determining 406 an updated active joint TCI state for the first communication device 100 based on the TCI update message 510.

FIG. 5 illustrates a communication system 500 according to embodiments of the invention. The communication system 500 in the disclosed embodiment comprises a first communication device 100 and a second communication device 300 configured to communicate and operate in the communication system 500. In a first variant, the first communication device 100 is a first client device and the second communication device 300 is a network access node. In a 3GPP scenario, they may hence communicate over an Uu interface in the UL and DL, and the first client device may be denoted a UE and the network access node may be denoted a gNB. However, in a second variant the second communication device 300 may in embodiments instead be a second client device different to the first client device as also shown in FIG. 5. The communication between the first communication device 100 and the second communication device 300 may in this latter example be performed over a so called sidelink (SL) interface which may be standardized by 3GPP.

A client device may herein be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station (STA), which is any device that contains an IEEE 802.11-conformant media access control (MAC) and physical layer (PHY) interface to the wireless medium (WM). The UE may be configured for communication in 3GPP related long term evolution (LTE), LTE-advanced, fifth generation (5G) wireless systems, such as new radio (NR), and their evolutions, as well as in IEEE related Wi-Fi, worldwide interoperability for microwave access (WiMAX) and their evolutions.

A network access node may herein also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access nodes may be of different classes or types such as e.g., macro eNodeB, home eNodeB or pico base station, based on transmission power and thereby the cell size. The radio network access node may further be a station (STA), which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

Generally, active joint TC states for the first communication device 100 and the second communication device 300 are configured and activated based on multiple RSs measurements in UL and/or DL. The active joint TCI state may be a set of joint TCI states configured for the first communication device 100 by the second communication device 300. The second communication device 300 then indicates an active joint TCI state from the set of configured joint TCS states to be used for a given transmission between the first communication device 100 and the second communication device 300. Each active joint TCI state indicates an association between at least one reception spatial filter B_{RXTX1}, B_{RXTX2}, . . . , B_{RXTXN} of the first communication device 100 with at least one transmission spatial filter B_{TXRX1′}, B_{TXRX2′}, . . . , B_{TXRXN′} of the second communication device 300 or at least one transmission spatial filter B_{RXTX1}, B_{RXTX2}, . . . , B_{RXTXN} of the first communication device 100 with at least one reception spatial filter B_{TXRX1′}, B_{TXRX2′}, . . . , B_{TXRXN′} of the second communication device 300, i.e., that the beams resulting from the respective spatial filters are quasi-collocated.

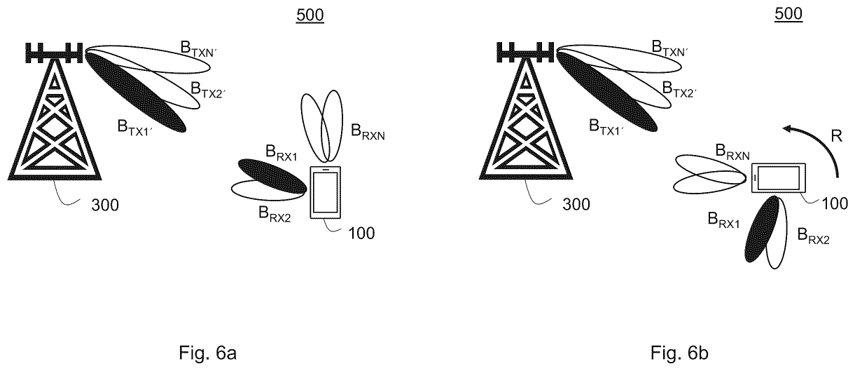

With reference to FIGS. 6a-b, a rotation R of the first communication device 100 may completely change the beam(s) that the first communication device 100 can use for UL transmission to or DL reception from the second communication device 300. The joint TCI state indicated by the second communication device 300 may hence no longer be optimal after a rotation of first communication device 100 and it may be beneficial to adapt the UL TCI state of the joint TCI state. That is to update associations between reception spatial filters B_{RX1}, B_{RX2}, . . . , B_{RXN} of the first communication device 100 and transmission spatial filters B_{TX1′}, B_{TX2′}, . . . , B_{TXN′} of the second communication device 300 or transmission spatial filters B_{TX1}, B_{TX2}, . . . , B_{TXN} of the first communication device 100 and reception spatial filters B_{RX1}′, B_{RX2}′, . . . , B_{RXN} of the second communication device 300.

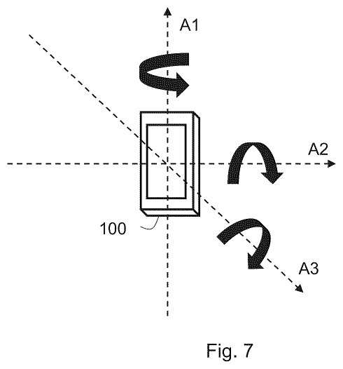

The rotation of the first communication device 100 may be around or in relation to one or more of its rotational axes A1, A2, A3 of the first communication device 100, as shown in FIG. 7. A rotation around the rotational axis A1, A2, A3 may in some case be referred to as a yaw, roll and pitch, respectively. The rotation of interest from the perspective of the first communication device 100 is the rotation which somehow influences the propagation properties between the first communication device 100 and the second communication device 300. Since one or more beams are used in the communication therebetween and such beams are defined or given by transmission spatial filters at the transmitter and reception spatial filters at the receiver, the first communication device 100 needs to detect or predict such rotation influencing the propagation properties. By detecting a rotation may be understood as that, based on reference signals measurements and/or output from internal sensors, the first communication device 100 detects an ongoing change in the orientation of the first communication device 100 along one of its rotational axis. For example, DL RS reference signal received power (RSRP) time series can be used by the first communication device 100 in order to detect an ongoing rotation. By predicating a rotation on the other hand may be understood as that, based on RS measurements and/or output from internal sensors, the first communication device 100 implements prediction algorithms that can provide it with an expected rotation possibly in a given time horizon. Non-limiting examples of internal sensors are accelerometers, gyroscopes and cameras.

In FIG. 6a, it is assumed that an active TCI state indicates an association between a first reception spatial filter B_{RX1} of the first communication device 100 and a first transmission spatial filter B_{TX1′} of the second communication device 300. The first communication device 100 may thus receive a DL transmission from the second communication device 300 using the reception spatial filter B_{RX1} of the first communication device 100.

In FIG. 6b, the first communication device 100 has rotated R such that the first reception spatial filter B_{RX1} of the first communication device 100 is no longer associated with the first transmission spatial filter B_{TX1′} of the second communication device 300. This means that the first reception spatial filter B_{RX1} of the first communication device 100 is no longer aligned with the first transmission spatial filter B_{TX1′} of the second communication device 300. This will lead to a drop in link quality which is conventionally addressed by initiating RS measurements both in DL and UL to identify the source of the problem since the network node is not aware of the reason for the link quality degradation or drop. If the joint TCI state could be updated without having to perform RS measurements, network and radio resources could be saved and latency minimized in the communication system 500.

According to embodiments of the invention a solution allowing the first communication device 100 to provide TCI state update information to the second communication device 100 is therefore provided. Upon detecting or predicting a rotation of the first communication device 100, the first communication device 100 determines a TCI state update for the active joint TCI state and provides an indication of the determined TCI state update to the second communication device 300. The TCI state update indication enables the second communication device 300 to e.g., avoid superfluous RS transmissions, especially in DL but also in the UL.

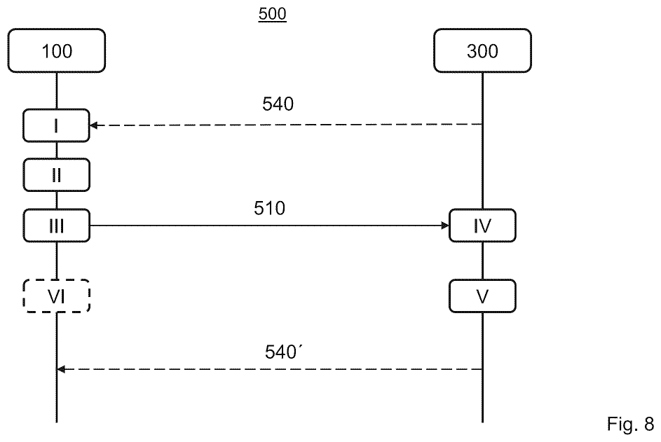

FIG. 8 shows a signaling diagram between a first communication device 100 and a second communication device 300 for providing a TCI state update according to an embodiment of the invention. The first communication device 100 may be a first client device, and the second communication device 300 may be a second client device or a network access node. The TCI state update may hence be provided over a Uu interface between a first client device and a network access node, e.g., between a UE and a gNB in a 3GPP scenario. The TCI state update may further be provided over a sidelink interface between a first client device and a second client device, e.g., between a UE and another UE in a 3GPP scenario.

In step I in FIG. 8, the first communication device 100 obtains an active joint TCI state. The active joint TCI state may be configured for the first communication device 100 and/or indicated to be used for a transmission/reception. As indicated with dashed arrow in FIG. 8, the first communication device 100 may obtain the active joint TCI state from the second communication device 300 in a TCI control message 540 indicating the active joint TCI state. In embodiments, the second communication device 300 may hence be configured to transmit a TCI control message 540 to the first communication device 100, the TCI control message 540 indicating an active joint TCI state for the first communication device 100. For a physical downlink shared channel (PDSCH) and/or physical uplink shared channel (PUSCH) transmission, the second communication device 300 may indicate the active joint TCI state in downlink control information (DCI).

The active joint TCI state associates at least one reception spatial filter B_{RXTX1}, B_{RXTX2}, . . . , B_{RXTXN} of the first communication device with at least one transmission spatial filter B_{TXRX1′}, B_{TXRX2′}, . . . , B_{TXRXN′} of the second communication device 300 or at least one transmission spatial filter B_{RXTX1}, B_{RXTX2}, . . . , B_{RXTXN} of the first communication device 100 with at least one reception spatial filter B_{TXRX1′}, B_{TXRX2′}, . . . , B_{TXRXN′} of the second communication device 300, as previously described. Hence, the active joint TCI state may indicate a QCL relation between RS resources of the first communication device 100 and the second communication device 300 and that a channel, such as PDSCH or PUSCH, needs to be transmitted or received with the same spatial filter as the source RS of the QCL relation.

Upon detecting or predicting a rotation of the first communication device 100, i.e., a change in orientation of the first communication device 100, the first communication device 100 determines a TCI state update for the active joint TCI state in step II in FIG. 8. Thus, a detection or prediction of a rotation may trigger the first communication device 100 to perform step II in FIG. 8. The rotation of the first communication device 100 may be around at least one rotational axis A1, A2, A3 of the first communication device 100, as shown in FIG. 7. The first communication device 100 may detect or predict the rotation of the first communication device 100 based on RS measurements and/or output from internal sensors S1, S2, . . . , SN of the first communication device 100 as previously described.

The TCI state update determined by the first communication device 100 in step II in FIG. 8 may be associated with a single antenna panel or a plurality of antennas panels of the first communication device 100. The first communication device 100 may e.g., determine an TCI state update associated with all its active antenna panels or determine an TCI state update associated with a single active antenna panel or a subset of the active antenna panels of the first communication device 100. Indeed, depending on the scenario and its capabilities, the first communication device 100 may be communicating with one or multiple network TRPs. If more than one antenna panel is used, either for reception or transmission, the first communication device 100 may need to determine a common TCI state update applicable for all active antenna panels, or a TCI state update per active antenna panel.

In embodiments, the TCI state update indicates a shift in the association of the active joint TCI state of at least one reception spatial filter B_{RXTX1}, B_{RXTX2}, . . . , B_{RXTXN} of the first communication device 100 with at least one transmission spatial filter B_{TXRX1′}, B_{TXRX2′}, . . . , B_{TXRXN′} of the second communication device 300 or at least one transmission spatial filter B_{RXTX1}, B_{RXTX2}, . . . , B_{RXTXN} of the first communication device 100 with at least one reception spatial filter B_{TXRX1′}, B_{TXRX2′}, . . . , B_{TXRXN′} of the second communication device 300. The active joint TCI state may refer to all configured active joint TCI states, or the active joint TCI state indicated for an ongoing transmission. By indicating a shift in the association of the active joint TCI state, the TCI state update can provide information about suitable UL/DL beam(s) for the first communication device 100 after the rotation.

The TCI state update may further indicate the rotation of the first communication device 100. In this way, the TCI state update may provide information to the second communication device 300 about the extent of change in orientation of the first communication device 100. Thus, a joint TCI state update is transmitted following the detection or prediction of a rotation of the first communication device 100. If the first communication device 100 transmits a joint TCI state update message of the present type, the second communication device 300 will understood that the joint TCI state update message is an implicit indication of a change in the first communication device 100 orientation, i.e., a rotation. Additionally, since the joint TCI state update message may indicate a shift in the association between UL and DL TCI states, the shift may also convey an estimation of the amount of rotation, whether predicted or detected. This simplifies beam adaptation.

In embodiments, the first communication device 100 determines the TCI state update based on a reference joint TCI state, i.e., the TCI state update may be determined in relation to a reference joint TCI state. In an example, the reference joint TCI state may be the latest joint TCI state indicated by the second communication device 300. Thus, the first communication device 100 may determine the TCI state update in relation to the latest joint TCI state, i.e., the active joint TCI state indicated by the second communication device 300 for the latest transmission, e.g., in the latest received DCI. By deriving the joint TCI state update with respect to a reference joint TCI state, the needed reporting format, such as bit-width, to convey the TCI state update indication may be optimized.

In step III in FIG. 8, the first communication device 100 transmits a TCI update message 510 to the second communication device 300. The TCI update message 510 indicates the TCI state update determined in step II in FIG. 8. The TCI update message 510 may be transmitted in the physical uplink control channel (PUCCH) or the physical uplink shared channel (PUSCH). Furthermore, the TCI state update may be indicated using dynamic L1 and/or L2 signaling. The TCI state update may e.g., be indicated in uplink control information (UCI) or UL medium access control (MAC) control element (CE).

In step IV in FIG. 8, the second communication device 300 receives the TCI update message 510 from the first communication device 100 and hence obtains the TCI state update for the active joint TCI state indicated in the TCI update message 510. Based on the TCI update message 510, the second communication device 300 determines an updated active joint TCI state for the first communication device 100, in step V in FIG. 8.

As previously described, the TCI state update may indicate a shift in the association of the active joint TCI state of at least one reception spatial filter B_{RXTX1}, B_{RXTX2}, . . . , B_{RXTXN} of the first communication device 100 with at least one transmission spatial filter B_{TXRX1′}, B_{TXRX2′}, . . . , B_{TXRXN′} of the second communication device 300 or at least one transmission spatial filter B_{RXTX1}, B_{RXTX2}, . . . , B_{RXTXN} of the first communication device 100 with at least one reception spatial filter B_{TXRX1′}, B_{TXRX2′}, . . . , B_{TXRXN′} of the second communication device 300. As aforementioned, the TCI state update may be associated with a single antenna panel of the first communication device 100 or a plurality of antenna panels and may also indicate a rotation of the first communication device 100 around at least one rotational axis A1, A2, A3 of the first communication device 100. The second communication device 300 may hence derive a lot of information from the indicated TCI state update which may be used to determine the updated active joint TCI state for the first communication device 100, in step V in FIG. 8.

Additional information may be considered by the second communication device 300 when determining the updated active joint TCI state for the first communication device 100. In embodiments, the second communication device 300 may determine the updated active joint TCI state further based on one or more in the group comprising channel state information (CSI), radio resource management measurements, and positioning measurements. The second communication device 300 may further collect data from other communication devices that have correlated mobility patterns with the first communication device 100 and use this information to determine the updated active joint TCI state. The determining in step V in FIG. 8 may further be based on network deployment and network layout knowledge. Indeed, while the first communication device 100 can determine an eventual joint TCI state update based on DL RS measurements, control information from the network and possible sensor measurements at the first communication device 100, the network can leverage more information, as first communication devices tend to have correlated mobility patterns in given area, and consequently the network may derive information about possible proper correction of joint TCI states, e.g., from previously performed beam management and joint TCI update procedures.

The second communication device 300 may determine the updated active joint TCI state based on the obtained TCI state update as part of a general beam management procedure. However, the second communication device 300 may further use the obtained TCI state update to optimize other procedures which may be impacted by a change in orientation of the first communication device 100. Examples of such procedures may include modulation coding scheme (MCS) selection, resource allocation, UL/DL power control, precoding matrix index (TPMI) indications. Indeed, link quality can change due to rotation of a first communication device. For example, angles of arrival of DL signals and angles of departure of UL signals could change due to such rotation. Additionally, the fading profile of the radio channel could change both in amplitude and phase. Consequently, the network needs to account for such changes in its scheduling and link adaptation decisions.

With reference to FIG. 8, the second communication device 300 may transmit a TCI control message 540′ to the first communication device 100, the TCI control message 540′ indicating the updated active joint TCI state. In this case, the first communication device 100 may e.g., use the indicated updated active joint TCI state for its next transmission and/or reception. Hence, the beam management is in this case network controlled.

However, the first communication device 100 may in embodiments autonomously update the active joint TCI based on the TCI state update determined in step II in FIG. 8, as indicated with optional step VI in FIG. 8. In this case, the first communication device 100 applies the joint TCI state update that it has derived, without waiting for the validation or TCI control message from the network. In such autonomously update procedure the first communication device 100 may convey the update in the TCI state update message 510. The fact that the first communication device 100 indicates the update it applied to QCL assumptions, to the second communication device 300, enables to avoid any ambiguity between the first communication device 100 and the network on the applied spatial filters and UL/DL beam association or correspondence. Autonomous joint TCI state update at the first communication device 100 may be configured or activated/deactivated dynamically by the network using control signaling. If autonomous joint TCI update is neither activated nor configured, the first communication device 100 may update the applied spatial filters only after receiving a TCI control message 540′ from the second communication device 300, following the transmission of a joint TCI state update message.

In step VI in FIG. 8, the first communication device 100 may switch at least one reception spatial filter B_{RXTX1}, B_{RXTX2}, . . . , B_{RXTXN} of the first communication device 100 and/or at least one transmission spatial filter B_{TXRX1}, B_{TXRX2}, . . . , B_{TXRXN} of the first communication device 100 based on the TCI state update. When a shift happens, the first communication device 100 may change the beam(s) that it uses for reception/transmission of DL transmission and/or UL transmission. These beams may be the same or different beams. Step VI in FIG. 8 may be independent of the steps performed by the second communication device 300 and may be performed anytime by the first communication device 100 once the TCI state update has been determined in step II in FIG. 8.

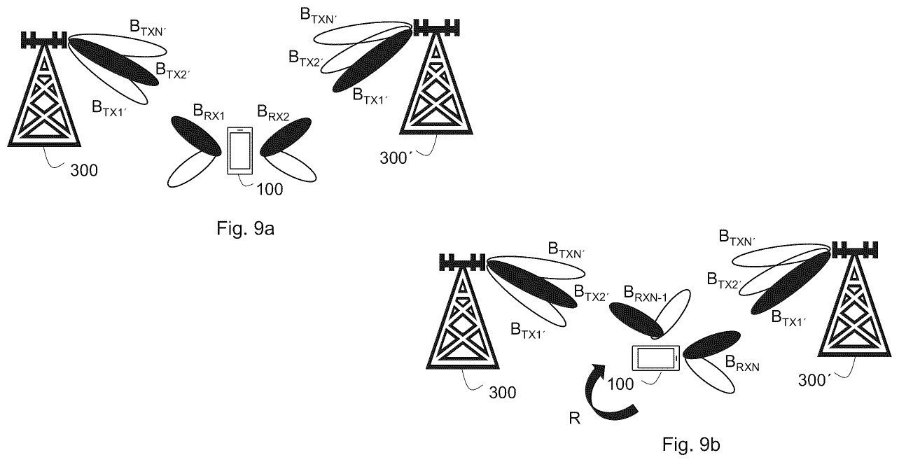

FIGS. 9a-b show how the first communication device 100 switches two reception spatial filters B_{RX1}, B_{RX2} based on a rotation according to an embodiment of the invention. FIG. 9a-b show a multiple-TRP scenario where the first communication device 100 communicates with two second communication devices 300, 300′. In FIG. 9a, the first communication device 100 uses two reception spatial filters B_{RX1}, B_{RX2}, one to each second communication devices 300, 300′. Upon detecting a clockwise rotation R, the first communication device 100 determines a TCI state update and provides the TCI state update to the two second communication devices 300, 300′. The first communication device 100 further switches to two new reception spatial filters B_{RXN-1}, B_{RXN} based on the TCI state update.

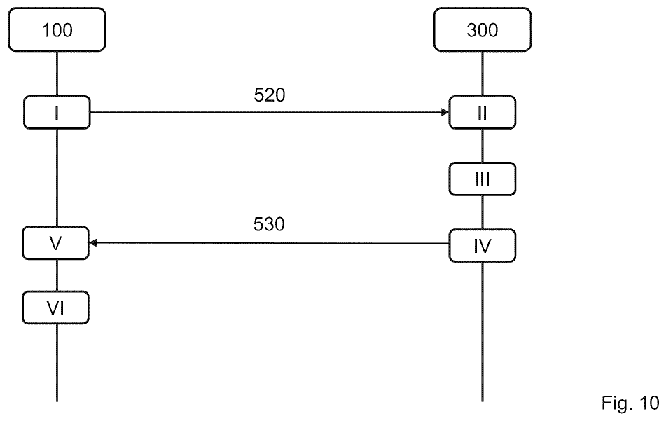

FIG. 10 shows signaling between a first communication device 100 and a second communication device 300 for configuration of joint TCI updates according to further embodiments of the invention. Especially, control signaling related to the TCI update mechanism of the present solution is disclosed in FIG. 10.

In step I in FIG. 10, the first communication device 100 transmits a TCI update capability message 520 to the second communication device 300. The TCI update capability message 520 indicates a TCI update capability of the first communication device 100, i.e., that the first communication 100 supports TCI state updates. The TCI update capability may e.g., be a binary bit indication indicating either capability or incapability for joint TCI state update. Additionally, the capability message may convey an indication of whether the first communication device 100 supports joint TCI state update indication for detected and/or predicted device orientation changes.

The second communication device 300 receives the TCI update capability message 520 from the first communication device 100, indicating the TCI update capability of the first communication device 100, in step II in FIG. 10. Based on the received TCI update capability message 520, the second communication device 300 determines a reporting format and/or reporting resources for the TCI update message 510 in step III in FIG. 10. The reporting format may e.g., indicate number of possible TCI state shifts or number of bits for encoding the indication of the TCI state update in UCI or UL MAC CE. The reporting resources are radio resources to be used by the first communication device 100 for reporting the TCI update. For example, the first communication device 100 may be configured with PUCCH resources to convey the joint TCI state update message. These resources may be the same or different from PUCCH resources used to convey hybrid automatic repeat request acknowledgement (HARQ-ACK) signaling. Alternately, the network may configure the first communication device 100 to transmit joint TCI state update message on PUSCH, eventually as part of CSI reports.

In step IV in FIG. 10, the second communication device 300 transmits a TCI update configuration message 530 to the first communication device 100. The TCI update configuration message 530 indicates the reporting format and/or the reporting resources for the TCI update message 510 determined by the second communication device 300. The TCI update configuration message 530 may be a RRC configuration message or be part of a RRC configuration message and/or procedure.

The first communication device 100 receives the TCI update configuration message 530 from the second communication device 300 in step V in FIG. 10. The first communication device 100 thereby derives the reporting format and/or reporting resources for the TCI update message 510 indicated in the TCI update configuration message 530.

In step VI in FIG. 10, the first communication device 100 determines the TCI update message 510 based on the TCI update configuration message 530. Hence, the first communication device 100 determines the reporting format and/or reporting resources for the TCI update message 510. The next time the first communication device 100 transmits a TCI update message 510 to the second communication device 300, the indicated reporting format is used and/or the TCI update message 510 is transmitted in the indicated reporting resources.

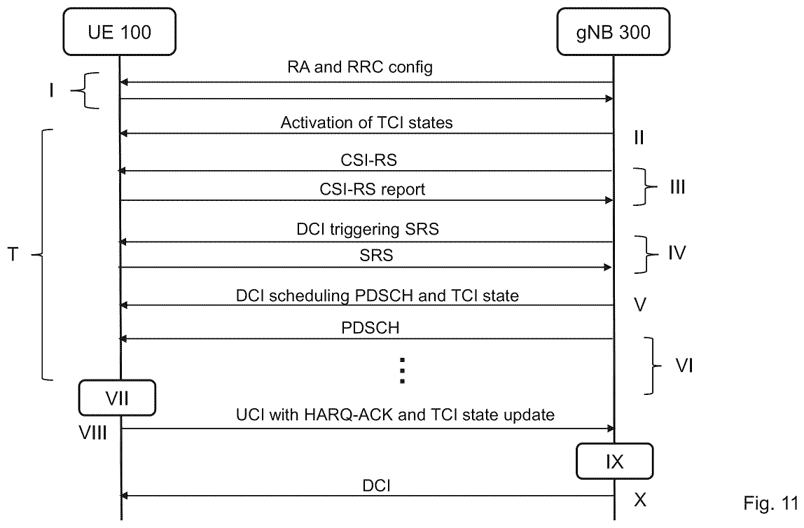

FIG. 11 shows an example of a general signaling diagram between a first communication device 100 and a second communication device 300 in a 3GPP framework where the first communication device 100 is configured as a client device, such as a UE, and the second communication device 300 is configured as a network access node, such as a gNB.

In step I in FIG. 11, the UE 100 performs a random access (RA) procedure to connect to a radio access network (RAN). When the UE 100 is in RRC connected state the gNB 300 configures the UE 100 with a RRC configuration in a conventional way. Hence, the RRC configuration may include information elements (IEs) relevant to triggering of TCI state updates and configuring the UE 100 with a set of joint TCI states.

In step II in FIG. 11, the gNB 300 transmits a MAC CE command indicating activation of one or more joint TCI states among the configured set of joint TCI states to the UE 100.

This is followed by transmission and reporting of CSI-RS and triggering and sending of aperiodic sounding reference signals (SRS), as shown in step III and IV in FIG. 11, respectively. Such transmission and reception between the UE and the gNB are performed via beams according to the activated joint TCI states.

In step V in FIG. 11, the gNB 300 schedules a DL transmission to the UE 100 in dynamic control signaling by sending a DCI scheduling DL transmission to the UE 100. The DCI also indicates joint TCI state to the UE 100.

The DL transmission to the UE 100 is performed in one or more PDSCH transmissions, as shown in step VI in FIG. 11.

Meanwhile, during a monitoring time period T in FIG. 11, the UE 100 is configured to detect or predict a rotation around its rotational axes that may influence the communication between the UE 100 and gNB 300. Therefore, during time period T, the UE may collect data relevant to mobility and rotation from internal sensors of the UE 100. The UE 100 may also use RS measurements and/or network indications, such as TCIs from other TRPs, for detecting or predicting the rotation. When the UE 100 detects or predicts a rotation of the UE 100 around its rotational axes, the UE 100 determines a TCI state update according to embodiments of the invention.

In step VII in FIG. 11, the UE 100 has detected or predicated a rotation and hence determines a TCI state update and signals an indication thereof in step VIII in FIG. 11. In an example, the UE 100 signals the TCI state update together with HARQ-ACK dynamically in UCI to the gNB 300 if a HARQ procedure is employed. By encoding the TCI state update together with the HARQ-ACK low overhead may be achieved and also implies low complex implementation of the herein proposed control signaling. It may be noted that the joint TCI state update message may not always be forcibly transmitted together with HARQ-ACK, and other dedicated UL resources may be configured to convey joint TCI state update messages.

In step IX in FIG. 11, the gNB 300 determines an updated active joint TCI state for the UE 100, i.e., derives appropriate joint TCI states for beam matching between the UE 100 and the gNB 300, based on the received TCI state update. However, the gNB 300 may also use other input information for determining the joint TCI states for the UE 100. For example, CSI reports, RS measurements, and a priori learned network layout characteristics may be used in this respect.

The gNB indicates the updated active joint TCI to the UE 100 using a MAC CE or a DCI, as shown in step X in FIG. 11. The MAC CE may comprise an activation command for activating one or more joint TCI states for transmission/reception in one or more of PUSCH, PUCCH, PDSCH and PDCCH. The UE 100 upon receiving the updated active joint TCI adapts its transmission and/or reception beams according to the updated active joint TCI.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a read-only memory (ROM), a programmable read-only memory (PROM), an erasable PROM (EPROM), a flash memory, an electrically erasable PROM (EEPROM), or a hard disk drive.

Moreover, it should be realized that the first and second communication devices comprise the necessary communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the solution.

Therefore, the processor(s) of the first and second communication devices may comprise, e.g., one or more instances of a central processing unit (CPU), a processing unit, a processing circuit, a processor, an application specific integrated circuit (ASIC), a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

What is claimed is:

1. A first communication device of a communication system, the first communication device comprising:
at least one memory; and
at least one processor configured with processor-executable instructions to:
determine a transmission configuration indication (TCI) state update for an active joint TC state upon detecting or predicting a rotation of the first communication device around at least one rotational axis of the first communication device,
wherein the active joint TC state associates:
at least one reception spatial filter of the first communication device with at least one transmission spatial filter of a second communication device, or
at least one transmission spatial filter of the first communication device with at least one reception spatial filter of the second communication device; and
transmit a TCI update message to the second communication device,
wherein the TCI update message indicates the TCI state update.

2. The first communication device according to claim 1, wherein the TCI state update indicates a shift in the association of the active joint TCI state of:
the at least one reception spatial filter of the first communication device with the at least one transmission spatial filter of the second communication device, or
the at least one transmission spatial filter of the first communication device with the at least one reception spatial filter of the second communication device.

3. The first communication device according to claim 1, wherein the TCI state update indicates the rotation of the first communication device.

4. The first communication device according to claim 1, wherein the at least one processor further configured with processor-executable instructions to determine the TCI state update based on a reference joint TCI state.

5. The first communication device according to claim 4, wherein the reference joint TCI state comprises a latest joint TCI state indicated by the second communication device.

6. The first communication device according to claim 1, wherein the at least one processor is further configured with the processor-executable instructions to:
detect or predict the rotation of the first communication device based on at least reference signal measurements or an output from at least one internal sensor of the first communication device.

7. The first communication device according to claim 1, wherein the at least one processor is further configured with processor-executable instructions to:
transmit a TCI update capability message to the second communication device,
wherein the TCI update capability message indicates a TCI update capability of the first communication device.

8. The first communication device according to claim 1, wherein the at least one processor is further configured with processor-executable instructions to:
receive a TCI update configuration message from the second communication device,
wherein the TCI update configuration message indicates a reporting format or at least one reporting resource for the TCI update message; and
determine the TCI update message based on the TCI update configuration message.

9. The first communication device according to claim 1, wherein the at least one processor is further configured with the processor-executable instructions to:
switch the at least one reception spatial filter of the first communication device or the at least one transmission spatial filter of the first communication device based on the TCI state update.

10. A method applied to a first communication device, the method comprising:
determining a transmission configuration indication (TCI) state update for an active joint TC state upon detecting or predicting a rotation of the first communication device around at least one rotational axis of the first communication device,
wherein the active joint TC state associates:
at least one reception spatial filter of the first communication device with at least one transmission spatial filter of a second communication device, or
at least one transmission spatial filter of the first communication device with at least one reception spatial filter of the second communication device; and
transmitting a TCI update message to the second communication device,
wherein the TCI update message indicates the TCI state update.

11. The method according to claim 10, wherein the TCI state update indicates a shift in the association of the active joint TCI state of:
the at least one reception spatial filter of the first communication device with the at least one transmission spatial filter of the second communication device, or
the at least one transmission spatial filter of the first communication device with the at least one reception spatial filter of the second communication device.

12. The method according to claim 10, wherein the TCI state update indicates the rotation of the first communication device.

13. The method according to claim 10, the method further comprising:
determining the TCI state update based on a reference joint TCI state.

14. The method according to claim 13, wherein the reference joint TCI state comprises a latest joint TCI state indicated by the second communication device.

15. The method according to claim 10, the method further comprising:
detecting or predicting the rotation of the first communication device based on at least reference signal measurements or an output from at least one sensor of the first communication device.

16. The method according to claim 10, the method further comprising:
transmitting a TCI update capability message to the second communication device,
wherein the TCI update capability message indicates a TCI update capability of the first communication device.

17. The method according to claim 10, the method further comprising:
receiving a TCI update configuration message from the second communication device,
wherein the TCI update configuration message indicates a reporting format or at least one reporting resource for the TCI update message; and
determining the TCI update message based on the TCI update configuration message.

18. The method according to claim 10, the method further comprising:
switching the at least one reception spatial filter of the first communication device or the at least one transmission spatial filter of the first communication device based on the TCI state update.

19. A non-transitory computer-readable storage medium storing computer instructions, that when executed by at least one processor, cause at least one processor to:
determine a transmission configuration indication (TCI) state update for an active joint TCI state upon detecting or predicting a rotation of a first communication device around at least one rotational axis of the first communication device,
wherein the active joint TC state associates:
at least one reception spatial filter of the first communication device with at least one transmission spatial filter of a second communication device, or
at least one transmission spatial filter of the first communication device with at least one reception spatial filter of the second communication device; and
transmit a TCI update message to the second communication device,
wherein the TCI update message indicates the TCI state update.

20. The non-transitory computer-readable storage medium according to claim 19, wherein the TCI state update indicates a shift in the association of the active joint TCI state of:
the at least one reception spatial filter of the first communication device with the at least one transmission spatial filter of the second communication device, or
the at least one transmission spatial filter of the first communication device with the at least one reception spatial filter of the second communication device.
